(19) United States
(12) Patent Application Publication
(10) Pub. No.: US 2020/0282983 A1
(43) Pub. Date: Sep. 10, 2020

(54) BRAKE ASSISTANCE APPARATUS, CONTROL APPARATUS, AND BRAKE ASSISTANCE METHOD FOR VEHICLE

(71) Applicants: DENSO CORPORATION, Kariya-city (JP); TOYOTA JIDOSHA KABUSHIKI KAISHA, Toyota-shi (JP)

(72) Inventors: Yosuke Ito, Kariya-city (JP); Akira Isogai, Kariya-city (JP); Akihiko Yamamuro, Toyota-shi (JP); Wataru Ike, Nagoya-shi (JP)

(21) Appl. No.: 16/882,138

(22) Filed: May 22, 2020

Related U.S. Application Data
(63) Continuation of application No. PCT/JP2018/039481, filed on Oct. 24, 2018.

(30) Foreign Application Priority Data
Nov. 24, 2017 (JP) 2017-225511

(51) Int. Cl. B60W 30/09; B60W 30/095; B60W 60/00; B60T 7/12

(52) U.S. Cl. CPC B60W 30/09; B60W 30/0956; B60W 2554/4045; B60T 7/12; B60W 2520/04; B60W 60/0018

(57) ABSTRACT

When there is a likelihood of an own vehicle colliding with a first object present in a travelling direction of the own vehicle based on detection results from a detecting unit, a brake assistance apparatus determines whether there is an avoidance area, that is an area in which there is no second object in the periphery of the first object present in the travelling direction, is available for avoiding the collision by steering of the own vehicle. When no avoidance area is present, the brake assistance apparatus increases a brake assistance level using a brake assisting unit to be higher than when the avoidance area is present, and causes the brake assisting unit to perform brake assistance. Increasing the brake assistance level includes at least one of: advancing a timing for starting brake assistance of the own vehicle; and increasing the strength of brake assistance of the own vehicle.

### CROSS-REFERENCE TO RELATED APPLICATIONS

The present application is a continuation application of International Application No. PCT/JP2018/039481, filed Oct. 24, 2018, which claims priority to Japanese Patent Application No. 2017-225511, filed Nov. 24, 2017. The contents of these applications are incorporated herein by reference in their entirety.

### BACKGROUND

### Technical Field

The present disclosure relates to a brake assistance apparatus, a control apparatus, and a brake assistance method for a vehicle.

### Related Art

A technology for avoiding collision with an obstacle that is present in the periphery of a vehicle based on detection results from a camera and a radar is known. In this technology, for example, when there is a likelihood of an own vehicle colliding with an obstacle ahead, the own vehicle is controlled to be braked.

### SUMMARY

An aspect of the present disclosure provides a brake assistance apparatus for a vehicle. The brake assistance apparatus includes: a detecting unit that detects an object in a periphery of an own vehicle; a brake assisting unit that assists in braking of the own vehicle; and a control unit that controls the brake assisting unit. When determined that there is a likelihood of the own vehicle colliding with a first object that is present in a travelling direction of the own vehicle based on detection results from the detecting unit, the control unit determines an avoidance area, that is an area in which there is no second object in the periphery of the first object that is present in the travelling direction of the own vehicle, is available for avoiding the collision by steering of the own vehicle. When no avoidance area is present, the control unit increases a brake assistance level of the own vehicle using the brake assisting unit to be higher than when the avoidance area is present, and causes the brake assisting unit to perform brake assistance. Increasing the brake assistance level includes at least one of: advancing a timing for starting brake assistance of the own vehicle; and increasing the strength of brake assistance of the own vehicle.

### BRIEF DESCRIPTION OF THE DRAWINGS

In the accompanying drawings:

FIG. 1 is a diagram of a vehicle that includes a brake assistance apparatus according to a first embodiment;

FIG. 2 is a diagram of the brake assistance apparatus;

FIG. 3 is a flowchart of a brake assistance method;

FIG. 4 is a diagram for explaining an overlap ratio and an avoidance area;

FIG. 5 is a map of relationship between the overlap ratio and a brake assistance level according to the first embodiment;

FIG. 6 is a map of relationship between the overlap ratio and the brake assistance level according to a second embodiment;

FIG. 7 is a map of relationship between the overlap ratio and the brake assistance level according to a third embodiment;

FIG. 8 is a diagram of an example in which the other object is an oncoming vehicle;

FIG. 9 is a diagram of an example in which the other object is a vehicle that approaches the own vehicle from behind and to the side of the own vehicle; and

FIG. 10 is a diagram of a vehicle that includes a brake assistance apparatus according to a sixth embodiment.

### DESCRIPTION OF THE EMBODIMENTS

A technology for avoiding collision with an obstacle that is present in the periphery of a vehicle based on detection results from a camera and a radar is known. JP-A-2017-56795 describes that, in a case in which there is a likelihood of an own vehicle colliding with an obstacle ahead, control to brake the own vehicle is performed when an overlap ratio between the own vehicle and the obstacle ahead is equal to or greater than a predetermined value that is based on a vehicle speed of the own vehicle, and control to brake the own vehicle is not performed when the overlap ratio is less than the predetermined value that is based on the vehicle speed of the own vehicle.

In the technology described in JP-A-2017-56795, whether the vehicle is braked is determined based on the overlap ratio. Therefore, for example, in a state in which another obstacle, such as a guardrail, is present in the periphery of the obstacle ahead and avoidance through steering avoidance is difficult, control to brake the own vehicle may not be performed when the overlap ratio is low.

An exemplary embodiment of the present disclosure provides a brake assistance apparatus for a vehicle. The brake assistance apparatus includes: a detecting unit that detects an object in a periphery of an own vehicle; a brake assisting unit that assists in braking of the own vehicle; a control unit that controls the brake assisting unit. In response to determining that there is a likelihood of the own vehicle colliding with a first object that is present in a travelling direction of the own vehicle based on detection results from the detecting unit, the control unit determines there is an avoidance area, that is an area in which there is no second object in the periphery of the first object that is present in the travelling direction of the own vehicle, is available for avoiding the collision by steering of the own vehicle. When no avoidance area is present, the control unit increases a brake assistance level of the own vehicle using the brake assisting unit to be higher than when the avoidance area is present, and causes the brake assisting unit to perform brake assistance. Increasing the brake assistance level includes at least one of: advancing a timing for starting brake assistance of the own vehicle; and increasing the strength of brake assistance of the own vehicle.

According to this exemplary embodiment, when the likelihood of a collision between the own vehicle and the first object that is present in the travelling direction of the own vehicle is present and the avoidance area is not present in the periphery of the first object, at least one of: brake assistance being started earlier and the strength of brake assistance being increased compared to that when the avoidance area is present is performed. Therefore, the likelihood of a collision between the own vehicle and the first object that is present in the travelling direction of the own vehicle can be reduced. In addition, the likelihood of a collision with the second object in the periphery of the first object can be reduced.

### First Embodiment

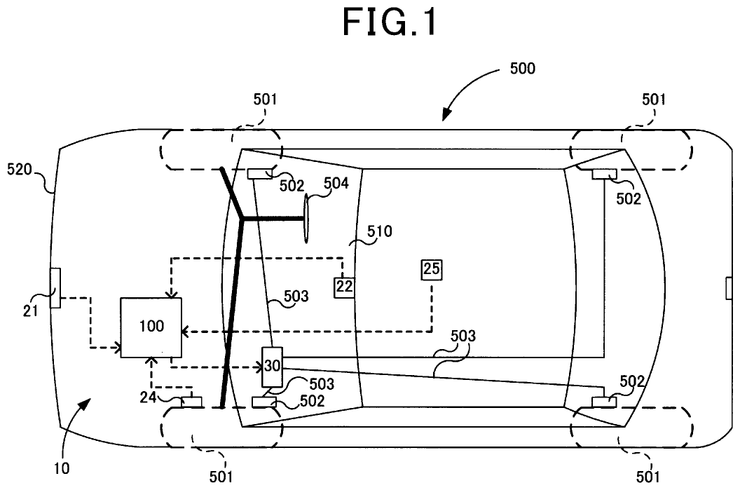

As shown in FIG. 1, a brake assistance apparatus 10 according to a first embodiment is used to be mounted in a vehicle 500. The brake assistance apparatus 10 includes a control unit 100, a millimeter-wave radar 21, a monocular camera 22, a vehicle speed sensor 24, a yaw rate sensor 25, a brake assistance actuator 30, and a brake apparatus 502. The vehicle 500 includes a wheel 501, a brake line 503, a steering wheel 504, a front windshield 510, and a front bumper 520.

As a detecting unit that detects an object in the periphery of an own vehicle, the vehicle 500 may be provided with at least the millimeter-wave radar 21. The vehicle 500 may be provided with at least one of the monocular camera 22 and a laser radar (LIDAR), together with the millimeter-wave radar 21. Alternatively, a stereo camera may be provided instead of the millimeter-wave radar 21. The stereo camera may be provided together with the millimeter-wave radar 21. According to the present embodiment, the millimeter-wave radar 21 and the monocular camera 22 are provided as the detecting unit.

The brake apparatus 502 is provided in each wheel 501. Each brake apparatus 502 actualizes braking of the wheel 501 by brake fluid pressure that is supplied through the brake line 503 based on a brake pedal operation by a driver. The brake line 503 includes a brake piston that generate the brake fluid pressure based on the brake pedal operation and a brake fluid line. According to the present embodiment, the brake assistance actuator 30 is provided in the brake line 503. Fluid pressure control can be performed independent of the brake pedal operation, and brake assistance is thereby actualized. Here, a configuration in which, instead of the brake fluid line, a control signal line is used as the brake line 503 and an electric actuator that is provided in each brake apparatus 502 is operated may be used. The brake assistance actuator 30 and the brake apparatus 502 are also collectively referred to as a “brake assisting unit”.

The steering wheel 504 is connected to the wheels 501 on a front side by a steering rod and a steering mechanism.

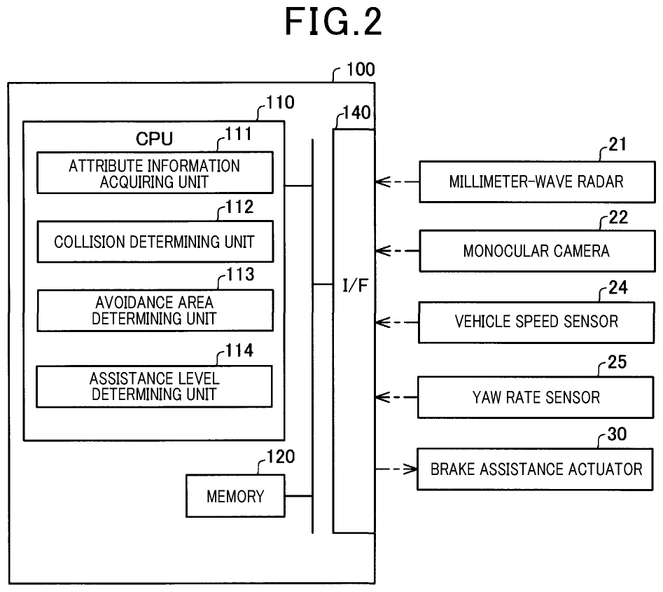

As shown in FIG. 2, the control unit 100 includes a central processing unit (CPU) 110, a memory 120, and an input/output interface 140. The control unit 100 includes a single CPU 110 or more. The CPU 110, the memory 120, and the input/output interface 140 are connected by a bus such as to be capable of two-way communication. For example, the memory 120 includes a read-only memory (ROM) and a random access memory (RAM). The millimeter-wave radar 21, the monocular camera 22, the vehicle speed sensor 24, the yaw rate sensor 25, and the brake assistance actuator 30 are each connected to the input/output interface 140 by a control signal line. Detection information of each sensor is inputted from the millimeter-wave radar 21, the monocular camera 22, the vehicle speed sensor 24, the yaw rate sensor 25. A control signal that designates a brake assistance level is outputted to the brake assistance actuator 30. The brake assistance level is a degree of intervention through brake assistance by the brake apparatus 502.

The CPU 110 functions as an attribute information acquiring unit 111, a collision determining unit 112, an avoidance area determining unit 113, and an assistance level determining unit 114 and performs brake assistance by expanding and running a program that is stored in the memory 120. Details of processes by the attribute information acquiring unit 111, the collision determining unit 112, the avoidance area determining unit 113, and the assistance level determining unit 114 will be described hereafter. Of the control unit 100, an apparatus that provides the functions of the avoidance area determining unit 113 and the assistance level determining unit 114 is also simply referred to as a “control apparatus”.

The millimeter-wave radar 21 is a sensor that emits millimeter waves and receives reflected waves that are reflected by an object, thereby detecting a position and a distance of the object. The millimeter-wave radar 21 includes a transmitter and a receiver. According to the present embodiment, the millimeter-wave radar 21 is arranged in a center of the front bumper 502. However, a plurality of millimeter-wave radars 21 may be provided on an overall surface of the front bumper 520. Alternatively, the millimeter-wave radars 21 may be arranged on both side surfaces of the front bumper 520. For example, detection signals outputted from the millimeter-wave radar 21 may be signals that are composed of a series of points that indicate representative positions of an object, obtained by reception waves being processed in a processing circuit provided in the millimeter-wave radars 21. Alternatively, the detection signals may be signals that indicate unprocessed reception waves. When the unprocessed reception waves are used as the detection signals, the CPU 110 performs signal processing to identify the position and distance of the object. Here, a LIDAR may be used instead of the millimeter-wave radar.

The monocular camera 22 is an imaging apparatus that includes a single image sensor, such as a charge coupled device (CCD). The monocular camera 22 is a sensor that outputs, as image data that is a detection result, outer appearance information on an object by receiving visible light. The image data outputted from the monocular camera 22 is configured by a plurality of frame images that are continuous in time series. Each frame image is expressed by pixel data. According to the present embodiment, the monocular camera 22 is arranged in an upper center portion of the front windshield 510. The pixel data outputted from the monocular camera 22 is monochromic pixel data or color pixel data.

The wheel speed sensor 24 is a sensor that detects a rotational speed of the wheel 501. The wheel speed sensor 24 is provided in each wheel 501. A detection signal outputted from the wheel speed sensor 24 is a voltage value that is proportional to a wheel speed or a pulse wave that indicates an interval based on the wheel speed. Information such as vehicle speed and traveling distance of the vehicle can be acquired based on the detection signal from the wheel speed sensor 24.

The yaw rate sensor 23 is a sensor that detects a rotation angle speed of the vehicle 500. For example, the yaw rate sensor 23 is arranged in a center portion of the vehicle 500. A detection signal outputted from the yaw rate sensor 23 is a voltage value that is proportional to a rotation direction and an angular speed.

The brake assistance actuator 30 is an actuator for performing braking by the brake apparatus 502 regardless of the brake pedal operation by the driver. According to the present embodiment, the brake assistance actuator 30 is provided on the brake line 503. The brake assistance actuator 30 increases and decreases the brake fluid pressure on the brake line 503 based on a control signal from the control apparatus 100. For example, the brake assistance actuator 30 is composed of a module that includes an electric motor and a brake hydraulic piston that is driven by the electric motor. Alternatively, a brake control actuator that is already provided as an anti-skidding apparatus or an anti-lock brake system may be used.

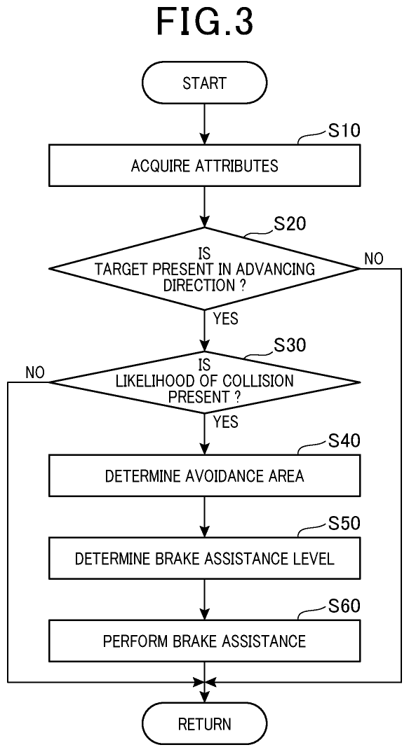

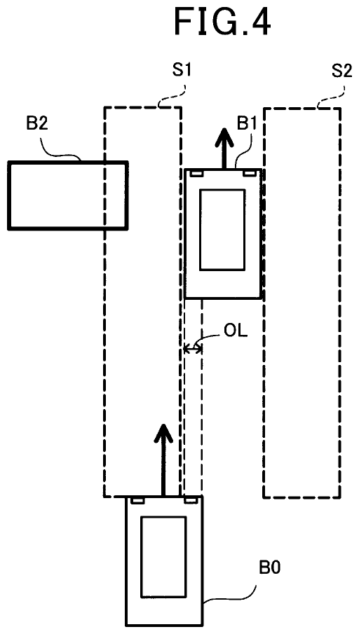

A brake assistance process that is performed by the brake assistance apparatus 10 according to the first embodiment will be described with reference to FIG. 3 and FIG. 4. Brake assistance is repeatedly performed by the CPU 110 from when a start switch of the vehicle 500 is turned until the start switch is turned off, or while a brake assistance switch that is provided in the vehicle 500 is set to on.

The attribute information acquiring unit 111 acquires attributes of an object in the periphery of an own vehicle B0 (FIG. 4) using the detection results that are inputted from the detecting unit, such as the millimeter-wave radar 21 and the monocular camera 22 (step S10 in FIG. 3). According to the present embodiment, as the attributes, for example, a distance from the own vehicle B0 to the object, a relative speed of the object relative to the own vehicle B0, an orientation of the object, a degree of overlap between the own vehicle B0 and the object, and a collision margin time (time-to-collision [TTC]) until the own vehicle B0 collides with the object are calculated and acquired, based on the detection results inputted from the millimeter-wave radar 21. In addition, for example, the attribute information acquiring unit 111 calculates and acquires a relative position of the object relative to the own vehicle B0, and the shape and size of the object, using the image data from the monocular camera 22.

Here, the degree of overlap is the degree of overlap of the object in the vehicle width direction of the own vehicle. Here, the degree of overlap is the degree of overlap of the object in a vehicle width direction of the own vehicle B0. According to the present embodiment, the degree of overlap is an overlap ratio OL of the own vehicle B0 and the object. The degree of overlap may be an amount of overlap with the object in the vehicle width direction of the own vehicle B0. The collision margin time TTC is an amount of time until the own vehicle B0 and the object collide under an assumption that the relative speed between the own vehicle B0 and the object is fixed. The attribute information acquiring unit 111 performs the above-described acquisition of the attributes at all times while the present routine is being performed.

Next, the collision determining unit 112 determines whether the object is present in a travelling direction of the own vehicle B0 using the attributes acquired by the attribute information acquiring unit 111 (step S20 in FIG. 3) When determined that the object is not present in the travelling direction of the own vehicle B0 (NO at step S20 in FIG. 3), the CPU 110 ends the present routine.

When determined that the object is present in the travelling direction of the own vehicle B0 (YES at step S20 in FIG. 30), the collision determining unit 112 determines whether a likelihood of the own vehicle B0 colliding with the object that that is present in the travelling direction of the own vehicle B0 is present using the attributes acquired by the attribute information acquiring unit 111 (step S30 in FIG. 3).

At step S30, when the overlap ratio OL is greater than 0 and the collision margin time TTC is equal to or less than a first threshold that is based on the relative speed stored in the memory 120, the collision determining unit 112 determines that the likelihood of a collision between the own vehicle B0 and an object B1 (corresponding to a first object) is present (YES at step S30 in FIG. 3). When the likelihood of a collision is not present (NO at step S30 in FIG. 3), the CPU 110 ends the present routine. The first threshold is a value that enables a collision with the object B1 to be avoided by braking of the own vehicle B0 when the driver operates the brake pedal of the own vehicle B0 when the collision margin time TTC is at the first threshold.

The vehicle 500 includes a warning apparatus that gives notification of the likelihood of a collision through sound, light, or vibrations. For example, before step S30, the CPU 110 may output a signal through the input/output interface 140 at a timing at which the collision margin time TTC reaches a second threshold that is longer than the above-described first threshold, and perform notification by the notification apparatus. Here, in an example shown in FIG. 4, the object B1 is a leading vehicle of the own vehicle B0. However, the object B1 is not limited to a four-wheeled vehicle and may be another moving object, such as a two-wheeled vehicle or a person, or may be a stationary object, such as a solid structure.

When the collision determining unit 112 determines that the likelihood of a collision is present, the avoidance area determining unit 113 determines there is an avoidance area in the periphery of the object B1 (step S40 in FIG. 3). The avoidance area is an area in which there is no other object in the periphery of the object B1 that is present in the travelling direction of the own vehicle B0, and is an area is available for avoiding a collision with the object B1 by steering of the own vehicle B0. The other object is an object that differs from the object B1. According to the present embodiment, the other object B2 (corresponding to a second object) is a stationary object such as a broken-down vehicle or a guardrail.

According to the present embodiment, for example, the avoidance area determining unit 113 calculates a lateral movement amount of the own vehicle B0 that is required to avoid a collision between the own vehicle B0 and the object B1 by multiplying the vehicle width of the own vehicle B0 by the overlap ratio OL. The avoidance area determining unit 113 then estimates a traveling trajectory area that is an area through which the own vehicle B0 travels under an assumption that the own vehicle B0 is traveling at a current vehicle speed and steering based on the lateral movement amount is performed in the own vehicle B0.

The avoidance area determining unit 113 determines whether there is a pixel area that indicates the other object is present in the estimated traveling trajectory area, using the detection results from the millimeter-wave radar 21 and the monocular camera 22. The avoidance area determining unit 113 determines that no avoidance area is present when there is no pixel area indicating the other object in the estimated traveling trajectory area, and determines that the avoidance area is present when there is a pixel area indicating the other object in the estimated traveling trajectory area.

An area S1 on a left side of the object B1 in FIG. 4 is the estimated traveling trajectory area, and the other object B2 is present in the area S1. An area S2 on a right side of the object B1 shown in FIG. 4 is an area to which the own vehicle B0 cannot move by the collision margin time TTC. In the example shown in FIG. 4, the avoidance area determining unit 113 determines that the avoidance area is not present.

After determination of the avoidance area, the assistance level determining unit 114 determines the brake assistance level of the own vehicle B0 by the brake assistance unit based on the presence/absence of the avoidance area (step S50 in FIG. 3). When the avoidance area is not present, the assistance level determining unit 114 determines a higher brake assistance level compared to that when the avoidance area is present. According to the present embodiment, the brake assistance level prescribes a timing for starting brake assistance. Increasing the brake assistance level means advancing the timing for starting brake assistance of the own vehicle B0 by the brake assisting unit.

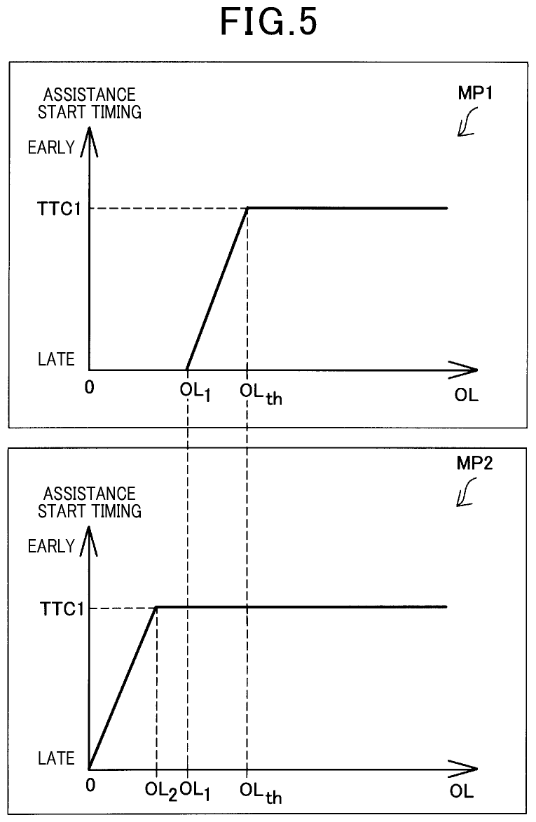

According to the present embodiment, the memory 120 stores therein a map MP1 and a map MP2, shown in FIG. 5. The map MP1 indicates the timing for starting brake assistance when the avoidance area is present. The map MP2 indicates the timing for starting brake assistance when the avoidance area is not present. The assistance level determining unit 114 references the map MP1 when the avoidance area is present and references the map MP2 when the avoidance area is not present, and determines the timing for starting brake assistance corresponding to the overlap ratio OL.

In the map MP1, the overlap ratio OL and the timing for starting brake assistance are set such that, when the overlap ratio OL is less than a predetermined value (hereafter, threshold OLth), the timing for starting brake assistance is later compared to that when the overlap ratio OL is equal to or greater than the threshold OLth, or brake assistance is not performed. Specifically, in the map MP1 for when the avoidance area is present, the relationship between the overlap ratio OL and the timing for starting brake assistance is set such that brake assistance is started at a timing at which the collision margin time reaches TTC1 when the overlap ratio OL is equal to or greater than the threshold OLth. The timing for starting brake assistance becomes later as the overlap ratio OL becomes less than the threshold OLth. Brake assistance is not performed when the overlap ratio OL is equal to or less than a value OL1 that is less than the threshold OLth. For example, the threshold OLth is 40%. For example, the timing TTC1 for brake assistance start at the threshold OLth is a timing at which the collision margin time TTC is 1.4 seconds. For example, the value OL1 is 30% or 25%.

Here, the relationship between the overlap ratio OL and the timing for starting brake assistance is set as described above because, when the overlap ratio OL is small, collision avoidance through operation of the steering wheel 504 is easier compared to that in the case of a full lap, for example. In addition, for example, when the own vehicle B0 is attempting to avoid and overtake the object B1, the own vehicle B0 may intentionally approach the object B1. When brake assistance is actively performed in such cases, the brake apparatus 502 of the own vehicle B0 may operate regardless of the intentions of the driver when the own vehicle B0 is attempting to overtake the object B1. As a result, a likelihood of overtaking not being achieved and a likelihood of the driver of the own vehicle B0 experiencing discomfort are present. The foregoing is to reduce such likelihoods.

In the map M2 for when the avoidance area is not present, the relationship between the overlap ratio OL and the timing for starting brake assistance is set such that brake assistance is started at the timing at which the collision margin time becomes TTC1 when the overlap ratio OL is equal to or greater than a value OL2. The timing for starting brake assistance becomes later as the overlap ratio OL becomes less than the value OL2. Brake assistance is not performed when the overlap ratio OL reaches 0. The value OL2 at which the timing for starting brake assistance starts to become later in the map MP2 is less than the value OLth at which the timing for starting brake assistance starts to become later in the map MP1. For example, the value OL2 is a value such as 5%, 10%, or 15%.

Next, the assistance level determining unit 114 outputs a signal to the brake assistance actuator 30 such that brake assistance is performed at the determined timing for starting brake assistance, and causes the brake apparatus 502 to perform brake assistance (step S60 in FIG. 3).

According to the first embodiment, the timing at which brake assistance is started when the likelihood of a collision between the own vehicle B0 and the object B1 that is present in the travelling direction of the own vehicle B0 is present, the avoidance area is not present in the periphery of the object B1, and the degree of overlap OL is less than the predetermined value OLth becomes earlier compared to the timing at which brake assistance is started when the avoidance area is present. Therefore, the likelihood of a collision between the own vehicle B0 and the object B1 that is present in the travelling direction of the own vehicle B0 can be reduced. In addition, when the other object B2 is present in the periphery of the object B1, the likelihood of a collision between the own vehicle B0 and the other object B2 can be reduced.

Furthermore, according to the first embodiment, even when the overlap ratio OL is relatively small, brake assistance is performed when the avoidance area is not present. Therefore, the likelihood of a collision between the own vehicle B0 and the object B1 that is present in the travelling direction of the own vehicle B0 can be reduced. Moreover, when the other object B2 is present in the periphery of the object B1, the likelihood of a collision between the own vehicle B0 and the other object B2 can be reduced.

### Second Embodiment

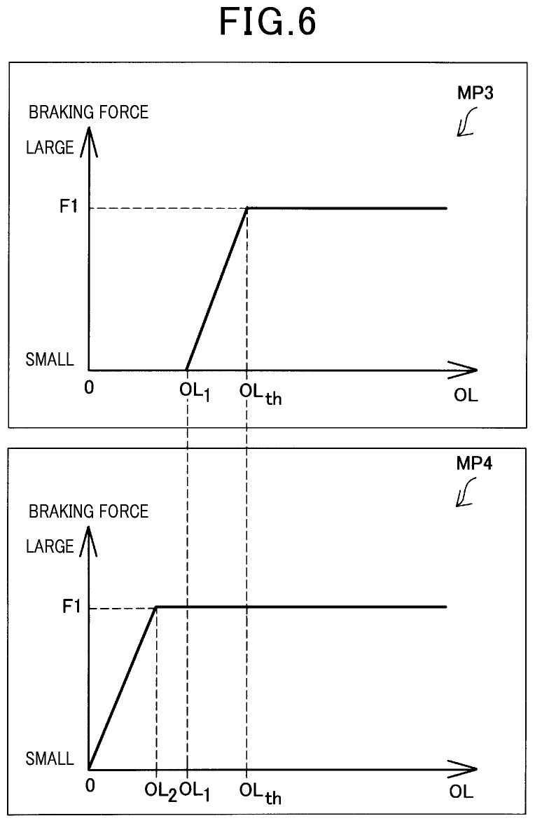

The brake assistance apparatus 10 according to a second embodiment will be described with reference to FIG. 6, mainly focusing on differences with the first embodiment. According to the second embodiment, the brake assistance level prescribes strength of brake assistance. According to the second embodiment, increase in the brake assistance level means increase in the strength of brake assistance of the own vehicle B0 by the brake assisting unit. In other words, a braking force that is generated by the brake assistance unit is increased.

According to the present embodiment, the memory 120 stores therein a map MP3 and a map MP4, shown in FIG. 6. The map MP3 indicates a magnitude of the braking force when the avoidance area is present. The map MP4 indicates the magnitude of the braking force when the avoidance area is not present. The assistance level determining unit 114 references the map MP3 when the avoidance area is present and references the map MP4 when the avoidance area is not present, and determines the magnitude of the braking force. According to the present embodiment, the maps MP3 and MP4 show the relationships between the overlap ratio OL and the magnitude of the braking force when the collision margin time TTC is the above-described first threshold. However, the maps MP3 and MP4 may show the relationships when the collision margin time TTC is the above-described second threshold.

As shown in FIG. 6, in the map MP3 for when the avoidance area is present, the relationship between the overlap ratio OL and the braking force is set such that, when the overlap ratio OL is less than the threshold OLth, the braking force is smaller compared to that when the overlap ratio OL is equal to or greater than the threshold OLth, or brake assistance is not performed. Specifically, in the map MP3, the relationship between the overlap ratio and the magnitude of the braking force is set such that brake assistance is performed at a magnitude of braking force F1 when the overlap ratio OL is equal to or greater than the threshold OLth. The braking force decreases as the overlap ratio OL becomes less than the threshold OLth. The braking force becomes zero when the overlap ratio OL is equal to or less than the value OL1 that is less than the threshold OLth.

For example, the magnitude of braking force F1 when the overlap ratio OL is equal to or greater than the threshold OLth is 3G. Here, 1G is acceleration that is of a same magnitude as gravitational acceleration. The relationship between the overlap ratio OL and the magnitude of the braking force is set as described above so that, in a manner similar to the timing for starting brake assistance being set based on the overlap ratio OL according to the first embodiment, a likelihood of overtaking not being achieved and a likelihood of the driver of the own vehicle B0 experiencing discomfort as a result of the brake apparatus 502 of the own vehicle B0 operating regardless of the intentions of the driver are reduced.

In the map MP4 for when the avoidance area is not present, the relationship between the overlap ratio OL and the braking force is set such that brake assistance is performed at the magnitude of braking force F1 when the overlap ratio OL is equal to or greater than the value OL2. The braking force decreases as the overlap ratio OL becomes less than the value OL2. Brake assistance is not performed when the overlap ratio OL reaches 0. The value OL2 at which the braking force starts to decrease in the map MP4 is less than the threshold OLth at which the braking force starts to decrease in the map MP3.

According to the second embodiment, the braking force when the likelihood of a collision between the own vehicle B0 and the object B1 that is present in the travelling direction of the own vehicle B0 is present, the avoidance area is not present in the periphery of the object B1, and the degree of overlap OL is less than the predetermined threshold OLth is greater than the braking force when the avoidance area is present. Therefore, the likelihood of a collision between the own vehicle B0 and the object B1 that is present in the travelling direction of the own vehicle B0 can be reduced. In addition, when the other object B2 is present in the periphery of the object B1, the likelihood of a collision between the own vehicle B0 and the other object B2 can be reduced.

Furthermore, in a manner similar to that according to the first embodiment, even when the overlap ratio OL is relatively small, brake assistance is performed when the avoidance area is not present. Therefore, the likelihood of a collision between the own vehicle B0 and the object B1 that is present in the travelling direction of the own vehicle B0 can be reduced. Moreover, when the other object B2 is present in the periphery of the object B1, the likelihood of a collision between the own vehicle B0 and the other object B2 can be reduced.

### Third Embodiment

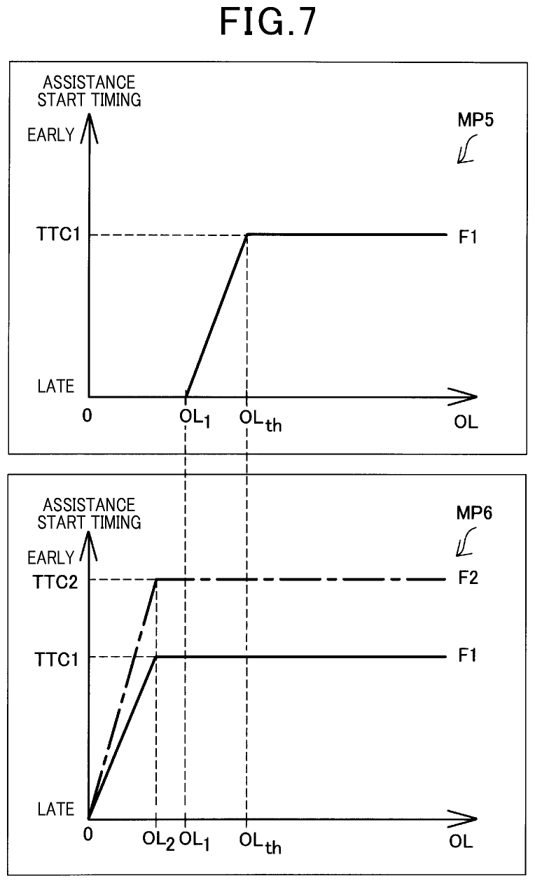

The brake assistance apparatus 10 according to a third embodiment will be described with reference to FIG. 7, mainly focusing on differences with the first embodiment and the second embodiment. According to the third embodiment, the brake assistance level prescribes the timing for starting brake assistance and the magnitude of the braking force. According to the third embodiment, an increase in the brake assistance level means advancing of the timing for starting brake assistance of the own vehicle B0 by the brake assisting unit and increase in the braking force.

According to the present embodiment, the memory 120 stores therein a map MP5 and a map MP6, shown in FIG. 7. The map MP5 shows the timing for starting brake assistance when the avoidance area is present. The map MP6 shows the timing for starting brake assistance and the magnitude of the braking force when the avoidance area is not present. The assistance level determining unit 114 references the map MP5 when the avoidance area is present and references the map MP6 when the avoidance area is not present, and determines the magnitude of the braking force.

In the map MP5 for when the avoidance area is present, the relationship between the overlap ratio OL and the timing for starting brake assistance is set such that, when the overlap ratio OL is less than the threshold OLth, the timing for starting brake assistance is later compared to that when the overlap ratio OL is equal to or greater than the threshold OLth. For example, the first braking force F1 at the timing TTC1 for brake assistance start is 3 G.

In the map MP6 for when the avoidance area is not present, the relationship between the timing at which brake assistance is started at the first braking force F1 and the overlap ratio OL is similar to the relationship described using the map MP2 described according to the first embodiment. According to the present embodiment, when the avoidance area is not present, brake assistance is further performed at the second braking force F2 that is less than the first braking force F2 at a timing that is earlier than the timing at which brake assistance is started at the first braking force F1.

According to the third embodiment, when the likelihood of a collision between the own vehicle B0 and the object B1 that is present in the travelling direction of the own vehicle B0 is present and the avoidance area is not present in the periphery of the object B1, first, brake assistance is performed at the relatively small second braking force F2 and then brake assistance is subsequently performed at the first braking force F1 that is greater than the second braking force F2. As a result, brake assistance can be performed in multiple stages. The likelihood of a collision between the own vehicle B0 and the object B1 can be further reduced. In addition, when the other object B2 is present in the periphery of the object B1, the likelihood of a collision between the own vehicle B0 and the other object B2 can be reduced.

Furthermore, according to the third embodiment, even when the overlap ratio OL is relatively small, brake assistance is performed when the avoidance area is not present. Therefore, in a manner similar to that according to the first embodiment and the second embodiment, the likelihood of a collision between the own vehicle B0 and the object B1 that is present in the travelling direction of the own vehicle B0 can be reduced. Moreover, when the other object B2 is present in the periphery of the object B1, the likelihood of a collision between the own vehicle B0 and the other object B2 can be reduced.

### Fourth Embodiment

According to the various embodiments described above, the avoidance area determining unit 113 may determine that the avoidance area is not present when, in a case in which the above-described other object is a moving body and the vehicle 500 moves, by steering, to an area in the periphery of the object B1 that is present in the travelling direction of the vehicle 500, the other object is predicted to be positioned in the area to which the vehicle 500 moves.

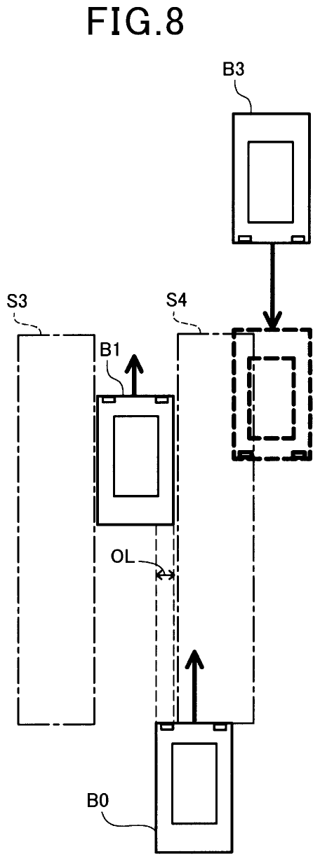

In an example shown in FIG. 8, the other object (corresponding to a second object) is an oncoming vehicle B3 that is traveling such as to oppose the travelling direction of the own vehicle B0. The attribute information acquiring unit 111 calculates and acquires a distance to the oncoming vehicle B3, a relative speed of the oncoming vehicle B3 relative to the own vehicle B0, an orientation of the oncoming vehicle B3, the overlap ratio OL of the own vehicle B0 and the oncoming vehicle B3, and the like, using the millimeter-wave radar 21 and the image data from the monocular camera 22.

The avoidance area determining unit 113 determines whether the oncoming vehicle B3 is present in the traveling trajectory area by the collision margin time TTC of collision with the object B1. In the example shown in FIG. 8, the oncoming vehicle B3 is present in an area S4 by the collision margin time TTC of collision with the object B1. An area S3 on the left side of the object B1 is an area to which the own vehicle B0 cannot move by the collision margin time TTC of collision with the object B1. In the example shown in FIG. 8, the avoidance area determining unit 113 determines that the avoidance area is not present.

According to the fourth embodiment, the avoidance area is determined to not be present when the other object is predicted to move to the area to which the own vehicle B0 is moved. The brake assistance level is determined to be a higher brake assistance level than that when the avoidance area is present. Therefore, the likelihood of collisions between the own vehicle B0 and the object B1, and between the own vehicle B0 and the other object can be reduced. In addition, the likelihood of collisions between the own vehicle B0 and the object B1, and between the own vehicle B0 and the oncoming vehicle B3 that is the other object can be reduced.

### Fifth Embodiment

According to the above-described embodiments, the detecting unit is the millimeter-wave radar 21 and the monocular camera 22 that are provided in the front of the vehicle 500. However, the vehicle 500 may further include a millimeter-wave radar and a monocular camera in the rear of the vehicle 500 as the detecting unit. The CPU 110 may detect a vehicle that approaches the own vehicle B0 from behind and to the side of the own vehicle B0, based on detection results from the rear millimeter-wave radar and monocular camera.

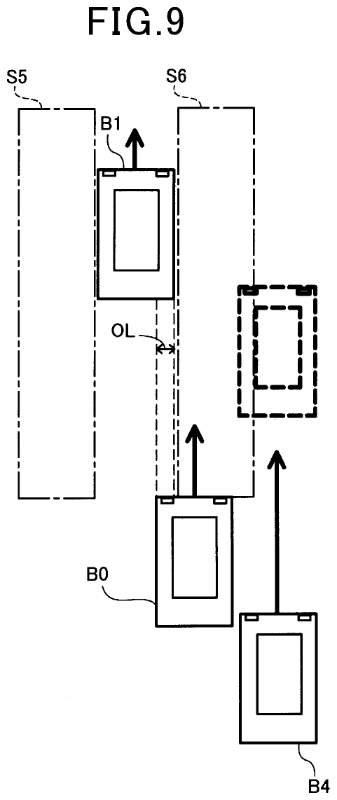

As shown in FIG. 9, when the other object (corresponding to a second object) is a vehicle B4 that approaches the own vehicle B0 from behind and to the side of the own vehicle B0, and when the own vehicle B0 moves, by steering, to an area S6 in the periphery of the object B1, the avoidance area determining unit 113 may determine that the avoidance area is not present when the vehicle B4 is predicted to be positioned in the area S6 to which the own vehicle B0 moves.

The attribute information acquiring unit 111 calculates and acquires a distance to the vehicle B4, a relative speed of the vehicle B4 relative to the own vehicle B0, an orientation of the vehicle B4, and the overlap ratio OL of the own vehicle B0 and the vehicle B4, using the image data from the millimeter-wave radar and the monocular camera provided in the rear of the vehicle 500. In an example in FIG. 9, the vehicle B4 is present in the area S6 by the collision margin time TTC of collision with the object B1. An area S5 on the left side of the object B1 is an area to which the own vehicle B0 cannot move by the collision margin time TTC of collision with the object B1. In the example shown in FIG. 9, the avoidance area determining unit 113 determines that the avoidance area is not present.

According to the fifth embodiment, the likelihood of a collision between the own vehicle B0 and the vehicle B4 that is approaching the own vehicle B0 from behind and to the side can be reduced.

### Sixth Embodiment

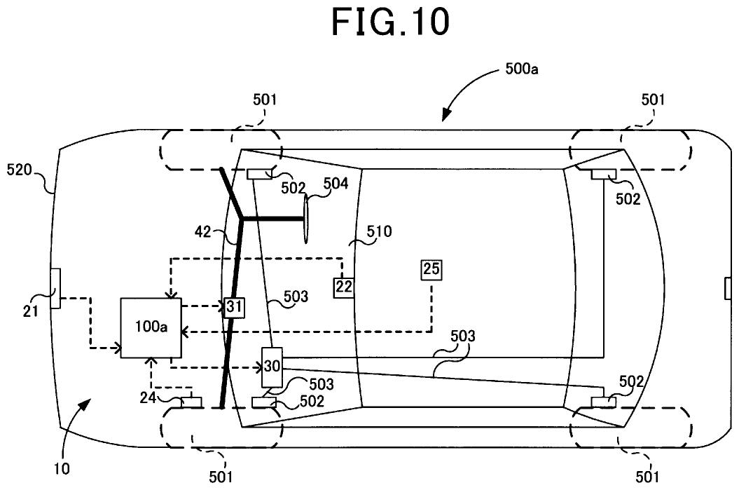

In a vehicle 500a that includes a brake assistance apparatus 10a according to a sixth embodiment shown in FIG. 10, the steering wheel 504 is connected to the wheels 501 on the front side by a steering apparatus 42 that includes a steering rod and a steering mechanism. For example, in the steering apparatus 42, a steering assistance apparatus 31 that is capable of driving the steering apparatus 42 by an actuator, such as an electric motor, is arranged. The steering assistance apparatus 31 is capable of controlling the steering apparatus 42 independent of the operation of the steering wheel 504. Steering assistance is performed by control by a control unit 100a. When the avoidance area is present, the control unit 100a may output a control signal to the steering apparatus 42 and cause the steering apparatus to perform steering assistance to the avoidance area. As a result of an embodiment such as this, the likelihood of a collision between the own vehicle B0 and the object can be reduced.

### Other Embodiments

According to the above-described embodiments, the assistance level determining unit 114 determines the timing for starting brake assistance or the magnitude of the braking force by referencing the maps that are stored in the memory. However, instead of the foregoing, an expression that expresses the relationship between the timing for starting brake assistance or the magnitude of the braking force, and the overlap ratio OL may be stored in the memory. The assistance level determining unit 114 may determine the timing for starting brake assistance or the magnitude of the braking force based on the overlap ratio OL.

The present disclosure can also be actualized according to various embodiments other than the brake assistance apparatus. For example, the present disclosure can be actualized according to embodiments such as a brake assistance method, a computer program for actualizing the method, a storage medium that stores therein the computer program, or a vehicle in which a collision estimation apparatus is mounted. In addition, according to the above-described embodiments, some or all of the functions and processes actualized by software may be actualized by hardware. Furthermore, some or all of the functions and processes actualized by hardware may be actualized by software. For example, as hardware, various circuits, such as integrated circuits, discrete circuits, and circuit modules combining integrated circuits and discrete circuits, may be used.

The present disclosure is not limited to the above-described embodiments. The present disclosure can be actualized through various configurations without departing from the spirit of the disclosure. For example, technical features according to the embodiments that correspond to technical features according to aspects described in the summary of the invention can be replaced and combined as appropriate to solve some or all of the above-described issued or to achieve some or all of the above-described effects. Furthermore, the technical features may be omitted as appropriate unless described as a requisite in the present specification.

What is claimed is:

1. A brake assistance apparatus for a vehicle, the brake assistance apparatus comprising:
a detecting unit that detects an object in a periphery of an own vehicle;
a brake assisting unit that assists in braking of the own vehicle; and
a control unit that controls the brake assisting unit, wherein
the control unit
determines, in response to determining that there is a likelihood of the own vehicle colliding with a first object that is present in a travelling direction of the own vehicle based on detection results from the detecting unit, whether there is an avoidance area for avoiding the collision by steering of the own vehicle that is an area in which there is no second object in the periphery of the first object that is present in the travelling direction of the own vehicle, and
increases, when no avoidance area is present, a brake assistance level of the own vehicle using the brake assisting unit to be higher than when the avoidance area is present, and causes the brake assisting unit to perform brake assistance, wherein increasing the brake assistance level includes at least one of: advancing a timing for starting brake assistance of the own vehicle; and increasing strength of brake assistance of the own vehicle.

2. The brake assistance apparatus according to claim 1, wherein:
the timing for starting brake assistance when the avoidance area is present is set such that, when a degree of overlap between the own vehicle and the first object in a vehicle width direction of the own vehicle is less than a predetermined value, the timing is later compared to that when the degree of overlap is equal to or greater than the predetermined value or brake assistance is not performed; and
when the avoidance area is not present and the degree of overlap is less than the predetermined value, the control unit advances the timing for starting brake assistance compared to that when the avoidance area is present and the degree of overlap is less than the predetermined value.

3. The brake assistance apparatus according to claim 2, wherein:
the strength of brake assistance when the avoidance area is present is set such that, when a degree of overlap between the own vehicle and the object in a vehicle width direction of the own vehicle is less than a predetermined value, the strength is less compared to that when the degree of overlap is equal to or greater than the predetermined value or brake assistance is not performed; and
when the avoidance area is not present and the degree of overlap is less than the predetermined value, the control unit increases the strength of brake assistance compared to that when the avoidance area is present and the degree of overlap is less than the predetermined value.

4. The brake assistance apparatus according to claim 3, wherein:
the second object is a moving body; and
the control unit determines that the avoidance area is not present when, in a case in which the own vehicle moves by steering to an area in the periphery of the first object that is present in the travelling direction of the own vehicle, the second object is predicted to be positioned in the area to which the own vehicle moves.

5. The brake assistance apparatus according to claim 4, wherein:
the second object is an oncoming vehicle of the own vehicle.

6. The brake assistance apparatus according to claim 4, wherein:
the second object is a vehicle that approaches the own vehicle from behind and to the side of the own vehicle.

7. The brake assistance apparatus according to claim 5, further comprising:
a steering apparatus that assists in steering of the own vehicle, wherein
the control unit causes the steering apparatus to perform steering assistance to the avoidance area when the avoidance area is present.

8. The brake assistance apparatus according to claim 6, further comprising:
a steering apparatus that assists in steering of the own vehicle, wherein
the control unit causes the steering apparatus to perform steering assistance to the avoidance area when the avoidance area is present.

9. The brake assistance apparatus according to claim 1, wherein:
the strength of brake assistance when the avoidance area is present is set such that, when a degree of overlap between the own vehicle and the object in a vehicle width direction of the own vehicle is less than a predetermined value, the strength is less compared to that when the degree of overlap is equal to or greater than the predetermined value or brake assistance is not performed; and
when the avoidance area is not present and the degree of overlap is less than the predetermined value, the control unit increases the strength of brake assistance compared to that when the avoidance area is present and the degree of overlap is less than the predetermined value.

10. The brake assistance apparatus according to claim 1, wherein:
the second object is a moving body; and
the control unit determines that the avoidance area is not present when, in a case in which the own vehicle moves by steering to an area in the periphery of the first object that is present in the travelling direction of the own vehicle, the second object is predicted to be positioned in the area to which the own vehicle moves.

11. The brake assistance apparatus according to claim 1, further comprising:
a steering apparatus that assists in steering of the own vehicle, wherein
the control unit causes the steering apparatus to perform steering assistance to the avoidance area when the avoidance area is present.

12. A brake assistance method for a vehicle, comprising:
determining, in response to determining that there is a likelihood of an own vehicle colliding with a first object that is present in a travelling direction of the own vehicle based on detection results from a detecting unit that detects an object in a periphery of the own vehicle, whether there is an avoidance area for avoiding the collision by steering of the own vehicle that is an area in which there is no second object in the periphery of the first object that is present in the travelling direction of the own vehicle; and
increasing, when no avoidance area is present, a brake assistance level of the own vehicle using a brake assisting unit that assists in braking of the own vehicle to be higher than when the avoidance area is present, wherein increasing the brake assistance level includes at least one of: advancing a timing for starting brake assistance of the own vehicle by the brake assisting unit; and increasing strength of brake assistance of the own vehicle by the brake assisting unit.

13. A control apparatus for a vehicle, comprising:
an avoidance area determining unit that, in response to determining that there is a likelihood of an own vehicle colliding with a first object that is present in a travelling direction of the own vehicle based on attribute information on an object in a periphery of the own vehicle, determines whether there is an avoidance area for avoiding the collision by steering of the own vehicle that is an area in which there is no second object in the periphery of the first object that is present in the travelling direction of the own vehicle; and
an assistance level determining unit that, when no avoidance area is present, increases a brake assistance level of the vehicle using a brake assisting unit that assists in braking of the own vehicle to be higher than when the avoidance area is present, wherein increasing the brake assistance level includes at least one of: advancing a timing for starting brake assistance of the own vehicle by the brake assisting unit; and increasing strength of brake assistance of the own vehicle by the brake assisting unit.
